(19) United States
(12) Patent Application Publication
(10) Pub. No.: US 2014/0362393 A1
(43) Pub. Date: Dec. 11, 2014

(54) IMAGE FORMING APPARATUS, IMAGE FORMING APPARATUS CONTROL METHOD, AND RECORDING MEDIUM STORING IMAGE FORMING APPARATUS CONTROL PROGRAM

(71) Applicant: Masanori Kurosawa, Tokyo (JP)

(72) Inventor: Masanori Kurosawa, Tokyo (JP)

(73) Assignee: RICOH COMPANY, LTD., Tokyo (JP)

(21) Appl. No.: 14/294,066

(22) Filed: Jun. 2, 2014

(30) Foreign Application Priority Data
Jun. 10, 2013 (JP) 2013-122105

(51) Int. Cl. G06K 15/00

(52) U.S. Cl. CPC G06K 15/00
USPC 358/1.12

(57) ABSTRACT

An image forming apparatus includes a post-processing unit that holds printed sheets on which an image is formed and output for post-processing, a carrier unit that holds sheets to be carried to the post-processing unit, a sheet carriage controller that carries the sheets held on the carrier unit to the post-processing unit if the image forming and outputting process that includes the post-processing is interrupted and then resumed, a counter that counts the number of sheets carried from the carrier unit to the post-processing unit, and an image forming and outputting controller that instructs an image forming and outputting unit that forms and outputs an image other than images specified based on the counted number of sheets among images to be output in the interrupted image forming and outputting process and carries the printed sheets on which an image is formed and output to the post-processing unit.

### CROSS-REFERENCE TO RELATED APPLICATION

This patent application is based on and claims priority pursuant to 35 U.S.C. §119(a) to Japanese Patent Application No. 2013-122105, filed on Jun. 10, 2013 in the Japan Patent Office, the entire disclosure of which is hereby incorporated by reference herein.

### BACKGROUND

1. Technical Field

The present invention relates to an image forming apparatus, an image forming apparatus control method, and a recording medium storing an image forming apparatus control program.

2. Background Art

With increased computerization of information, image processing apparatuses such as printers and facsimiles used for outputting the computerized information and scanners used for computerizing documents have become indispensable. In most cases, these image processing apparatuses are configured as multifunctional peripherals (MFPs) that can be used as a printer, facsimile, scanner, and copier by implementing an image pickup function, image forming function, communication function, etc.

Among these image processing apparatuses, in the printers used for outputting computerized information, image processing that generates drawing information used for executing image formation with a print engine based on input image information is performed, and the print engine executes image formation on sheets of recording media based on the generated drawing image. Furthermore, in these kinds of printers, post-processing such as stapling and punching is performed on the output sheets on which images have been formed if necessary.

In the case of performing the post-processing described above, the output sheets on which images are formed are stored in paper tray for post-processing in the image forming apparatus (hereinafter referred to as “post-processing tray”), post-processing is performed on the output sheets stored in the post-processing tray, and the post-processed output sheets are ejected onto a paper output tray. In forming and outputting images with post-processing, if the image forming apparatus is shut down due to a power failure or the like and the image forming and outputting process is interrupted, the output sheets stored in the post-processing tray before the interruption stay in the post-processing tray without being post-processed. After restarting the image forming apparatus, the output sheets staying on the post-processing tray are ejected onto the paper output tray without being post-processed, and the process of forming and outputting images is performed again from the beginning after executing reprocessing of interrupted forming and outputting images.

The output sheets that stay in the post-processing tray are not damaged physically and pose no problem from a quality viewpoint. However, since the process of forming and outputting images is performed again from the beginning without reusing the output sheets, that results in over-consuming paper and toner, etc.

### SUMMARY

An example embodiment of the present invention provides an image forming apparatus includes a post-processing unit that holds printed sheets on which an image is formed and output for post-processing after forming and outputting the image, a carrier unit that holds sheets carried to the post-processing unit, a sheet carriage controller that carries the sheets held on the carrier unit to the post-processing unit if the image forming and outputting process that includes the post-processing is interrupted and then resumed, a counter that counts the number of sheets carried from the carrier unit to the post-processing unit, and an image forming and outputting controller that instructs an image forming and outputting unit that forms and outputs an image other than images specified based on the counted number of sheets among images to be output in the interrupted image forming and outputting process and carries the printed sheets on which an image is formed and output to the post-processing unit.

Further example embodiments of the present invention provide an image forming apparatus control method, and a non-transitory recording medium storing an image forming apparatus control program.

### BRIEF DESCRIPTION OF THE DRAWINGS

A more complete appreciation of the disclosure and many of the attendant advantages thereof will be readily obtained as the same becomes better understood by reference to the following detailed description when considered in conjunction with the accompanying drawings.

FIG. 1 is a block diagram illustrating a hardware configuration of an image forming apparatus as an embodiment of the present invention.

FIG. 2 is a block diagram illustrating a functional configuration of the image forming apparatus as an embodiment of the present invention.

FIG. 3 is a block diagram illustrating a functional configuration of a main controller in the image forming apparatus as an embodiment of the present invention.

FIG. 4 is a diagram illustrating a reprocessing confirmation screen as an embodiment of the present invention.

FIG. 5 is a flowchart illustrating a process performed by a print job processor as an embodiment of the present invention.

FIG. 6 is a sequence diagram illustrating operations performed by the image forming apparatus as an embodiment of the present invention.

### DETAILED DESCRIPTION

In describing preferred embodiments illustrated in the drawings, specific terminology is employed for the sake of clarity. However, the disclosure of this patent specification is not intended to be limited to the specific terminology so selected, and it is to be understood that each specific element includes all technical equivalents that have the same function, operate in a similar manner, and achieve a similar result.

In the following embodiment, in forming and outputting images, in case of performing post-processing on the output sheets on which images are formed, an image forming apparatus that can reduce printing cost in performing reprocessing after interrupting forming and outputting images is provided.

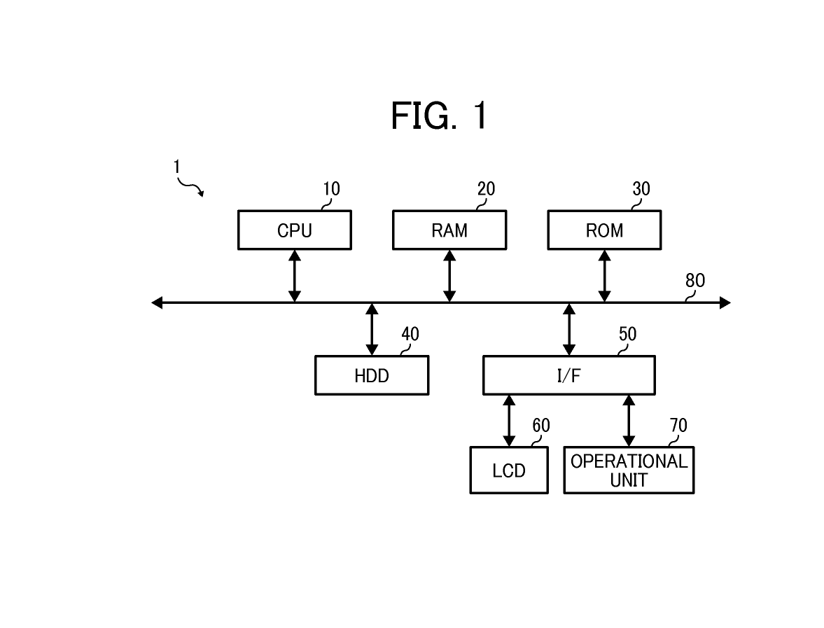

FIG. 1 is a block diagram illustrating a hardware configuration of the image forming apparatus 1. As shown in FIG. 1, the image forming apparatus 1 in this embodiment includes the same configuration as a general server or PC etc.

That is, in the image forming apparatus 1 in this embodiment, a Central Processing Unit (CPU) 10, a Random Access Memory (RAM) 20, a Read Only Memory (ROM) 30, a hard disk drive (HDD) 40, and an interface (I/F) 50 are connected with each other via a bus 80. In addition, a Liquid Crystal Display (LCD) 60 and an operational unit 70 are connected to the I/F 50. Besides, the image forming apparatus 1 includes an engine that executes forming an image, outputting the image, and scanning.

The CPU 10 is a processor and controls the overall operation of the image forming apparatus. The RAM 20 is a volatile storage device that can read/write information at high speed and is used as a work area when the CPU 10 processes information. The ROM 30 is a read-only nonvolatile storage device and stores programs such as firmware. The HDD 40 is a nonvolatile storage device that can read/write information and stores the operating system (OS), various control programs, and application programs, etc. In addition to the HDD, semiconductor memory devices such as a Solid State Drive (SSD) can be used.

The I/F 50 connects the bus 80 with various hardware and network, etc. and controls them. The LCD 60 is a visual user interface to check status of the image forming apparatus. The operational unit 70 is a user interface such as a keyboard, mouse, various hardware buttons, and touch panel to input information to the image forming apparatus.

In this hardware configuration described above, programs stored in storage devices such as the ROM 30, HDD 40, and optical discs (not shown in figures) are read to the RAM 20, and a software controlling unit is constructed by executing operation in accordance with the programs by the CPU 10. Functional blocks that implement functions of apparatuses that consist of the image processing system of this embodiment are constructed by a combination of the software controlling units described above and hardware.

Next, functions of the image forming apparatus 1 in this embodiment are described below.

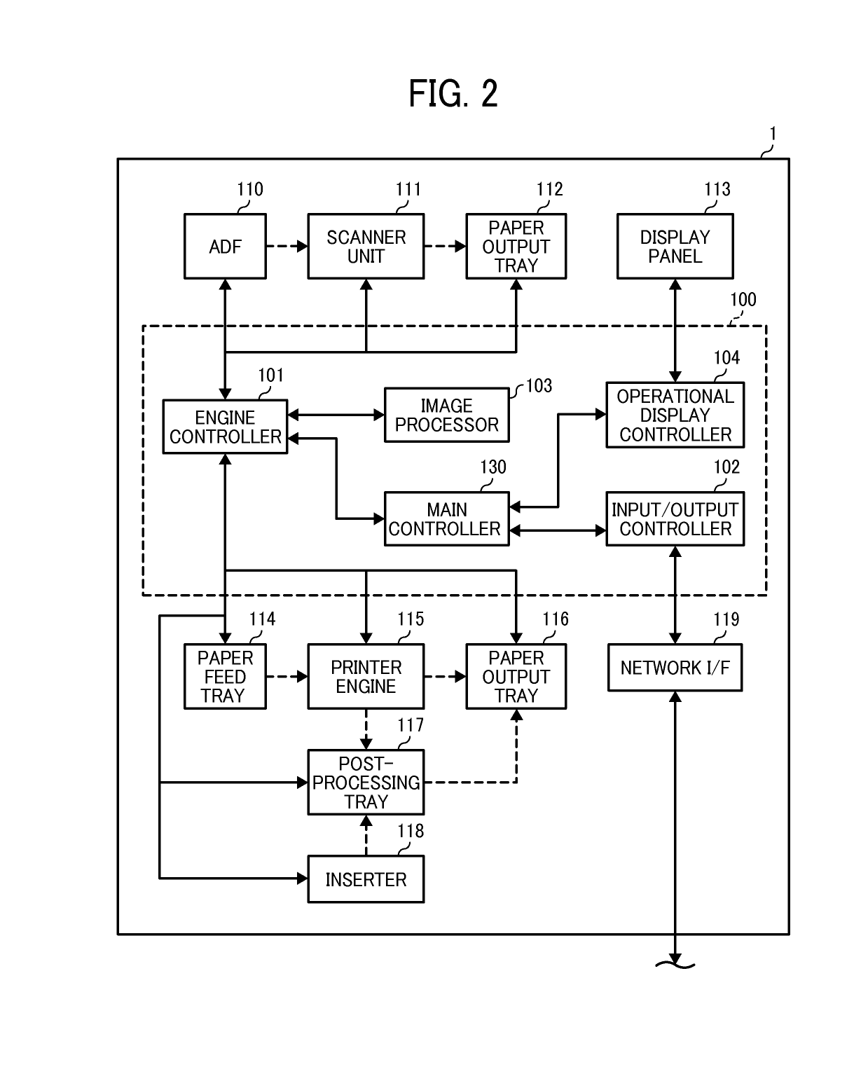

FIG. 2 is a block diagram illustrating a functional configuration of the image forming apparatus 1. As shown in FIG. 2, the image forming apparatus 1 includes a controller 100, an Auto Document Feeder (ADF) 110, a scanner unit 111, a paper output tray 112, a display panel 113, a paper feed table 114, a print engine 115, a paper output tray 116, a post-processing tray 117, an inserter 118, and a network I/F 119.

The controller 100 includes a main controller 130, an engine controller 101, an input/output controller 102, an image processor 103, and an operational display controller 104. As shown in FIG. 2, the image forming apparatus 1 in this embodiment is constructed as the MFP that includes the scanner unit 111 and the print engine 115. In FIG. 2, solid arrows indicate electrical connections, and dashed arrows indicate flow of paper.

The display panel 113 is both an output interface that displays status of the image forming apparatus 1 visually and an input interface (operational unit) to operate the image forming apparatus 1 directly or input information to the image forming apparatus 1.

The network I/F 119 is an interface that the image forming apparatus 1 communicates with other apparatuses via a network, and interfaces such as Ethernet, USB, Bluetooth, and Wireless Fidelity (Wi-Fi) are used for the network I/F 119.

The controller 100 combines software and hardware. In particular, control programs such as firmware stored in nonvolatile storage devices such as the ROM 30 and the HDD 40 are loaded into the RAM 20, and the software controlling unit is implemented by executing operations by the CPU 10 in accordance with the programs. The controller 100 is constructed of the software controlling unit and hardware such as integrated circuits. The controller 100 functions as a controller that controls the whole part of the image forming apparatus 1.

The main controller 130 controls each unit included in the controller 100 and commands each unit in the controller 100. The engine controller 101 controls and drives the print engine 115 and the scanner unit 111. The input/output controller 102 inputs signals and commands input via the network I/F 119 to the main controller 130. In addition, the main controller 130 controls the input/output controller 102 and accesses other apparatuses via the network I/F 119.

The image processor 103 generates drawing information based on image information to be printed and output under the control of the main controller 130. The drawing information is information that the print engine 115 as an image forming unit draws as an image to be formed in an image forming operation. The image processor 103 processes image pickup data input from the scanner unit 111 and generates image data. The generated image data is stored in the image forming apparatus 1 as a result of the scanner operation or transferred to another apparatus via the network I/F 119. The operational display controller 104 displays information on the display panel 113 and reports information input via the display panel to the main controller 130.

If the image forming apparatus 1 functions as the printer, first, the input output controller 102 receives a print job via the network I/F 119. The input/output controller 102 transfers the received print job to the main controller 130. After receiving the print job, the main controller 130 generates the drawing information based on the document information and image information included in the print job by controlling the image generator 103. After the image generator 103 generates the drawing information, the engine controller 101 executes forming an image on paper carried from the paper feed table 114 based on the generated drawing information. As particular examples of the print engine 115, image forming mechanisms such as inkjet method and electrophotography method can be used. After the print engine 115 forms the image on the paper, the paper is ejected on the paper output tray 116.

In case of performing post-processing such as stapling and punch on the document on which an image is formed by the print engine 115 (hereinafter referred to as “printed sheet”) after forming and outputting an image, the printed sheets are ejected and stored in the post-processing tray 117 that has a post-processing mechanism to perform post-processing. After finishing forming an image based on the print job, the engine controller 101 performs post-processing on the printed sheets stored in the post-processing tray 117. Sheets on which post-processing is performed by the post-processing mechanism (hereinafter referred to as “post-processed sheet”) are ejected on the paper output tray 116. That is, the post-processing tray 117 indicates a post-processing unit that the printed sheets are held to perform post-processing.

If the print job that includes post-processing is interrupted due to shutdown of the image forming apparatus 1 at unexpected timing etc., the printed sheets stored in the post-processing tray 117 before being interrupted are ejected on the paper output tray 116 without performing post-processing. Subsequently, the engine controller 101 drives the inserter 118 and carries paper set in the inserter 118 to the post-processing tray 117. That is, the inserter 118 indicates a carrier unit that holds the paper carried to the post-processing tray 117.

If the image forming apparatus 1 functions as a scanner, in response to a command to execute scanning input by operation on the display panel 113 or from an external apparatus via the network I/F 119, the operational display controller 104 or the input/output controller 102 transfers a signal to execute scanning to the main controller 130. The main controller 130 controls the engine controller 101 based on the received signal to execute scanning. The engine controller 101 drives the ADF 110 and carries a document to be scanned set on the ADF 110 to the scanner unit 111. In addition, the engine controller 101 drives the scanner unit 111 and scans the document carried from the ADF 110. If the document is not set on the ADF 110 and the document is set on the scanner unit 111 directly, the scanner unit 111 scans the set document under the control of the engine controller 101. That is, the scanner unit 111 functions as the image pickup unit.

In scanning operation, an image pickup device such as CCD included in the scanner unit 111 scans the document optically, and image pickup information is generated based on the optical information. The engine controller 101 transfers the image pickup information generated by the scanner unit 111 to the image processor 103. The image processor 103 generates the image information based on the image pickup information received from the engine controller 101 under the control of the main controller 130. The image information generated by the image processor 103 is stored in the storage device such as the HDD 40 attached to the image forming apparatus 1. The image information generated by the image processor 103 is either stored in the HDD 40 etc. as is or transferred to an external apparatus by the input/output controller 102 via the network I/F 119 depending on the user command.

If the image forming apparatus 1 functions as a copier, the image processor 103 generates the drawing information based on either the image pickup information received from the scanner unit 111 by the engine controller 101 or the image information generated by the image processor 103. Similarly as the printer operation, the engine controller 101 drives the print engine 115 based on the drawing information. In addition, similarly as the printer operation, post-processing is performed on the document on which the image is formed by the print engine 115.

In the configuration of the image processing apparatus 1 described above, the gist of the present invention is, in the image forming and outputting process that performs post-processing on the output printed sheets on which images are formed, to reduce the printing cost in resuming the interrupted image forming and outputting process. The image forming apparatus 1 in this embodiment reuses the printed sheets stored in the post-processing tray before interrupting forming and outputting images and performs forming and outputting images based on the drawing information not used for forming images due to the interruption of forming and outputting images. A functional configuration of the main controller 130 in this embodiment is described below. In the description below, the case in which the stapling process is performed as post-processing is taken as an example, and the post-processing tray 117 is considered as a stapling tray 117 that includes a stapling mechanism.

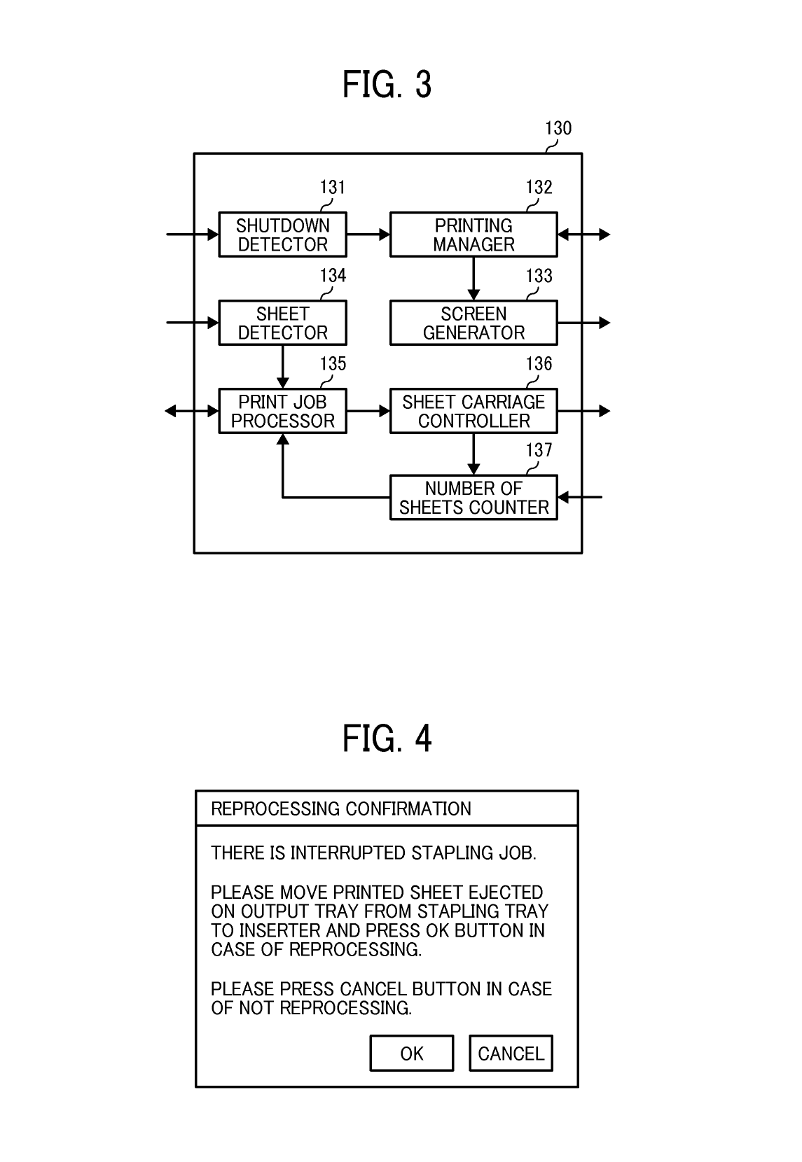

FIG. 3 is a block diagram illustrating a functional configuration of the main controller 130 in this embodiment. As shown in FIG. 3, the main controller 130 in this embodiment includes a shutdown detector 131, a printing manager 132, a screen generator 133, a sheet detector 134, a print job processor 135, a sheet carriage controller 136, and a counter 137.

If the image forming apparatus 1 was shut down improperly, the shutdown detector 131 detects that the improper shutdown occurred and reports to the printing manager 132 about that in rebooting after shutdown. Here, the improper shutdown means that the image forming apparatus 1 was shut down by performing improper shutdown operation such as the power supply of the image forming apparatus 1 stops working at unexpected timing etc.

The printing manager 132 manages the status of the printing process based on the print job input from the input/output controller 102 (image forming and outputting process). In addition, after receiving the notification of the improper shutdown from the shutdown detector 131, the printing manager 132 determines whether or not the print job interrupted the image forming process by the notified shutdown exists. Furthermore, if the print job interrupted the image forming process exists, the printing manager 132 determines whether or not the print job includes the stapling process (hereinafter referred to as “stapling job”). In addition, if the print job is the stapling job, the printing manager 132 tells the screen generator 133 to generate a confirmation screen to confirm whether or not reprocessing is performed based on the print job.

After receiving the notification from the printing manager 132, the screen generator 133 generates the reprocessing confirmation screen and outputs it to the operation display controller 104. FIG. 4 is a diagram illustrating the reprocessing confirmation screen generated by the screen generator 133. As shown in FIG. 4, a instruction to move the printed sheets ejected on the paper output tray from the staple tray due to the interruption and press OK button in case of reprocessing the interrupted stapling job and to press Cancel button in case of not reprocessing is displayed on the reprocessing confirmation screen.

The confirmation screen shown in FIG. 4 is displayed on the display panel 113 as the display unit under the control of the operation display controller 104. If the Cancel button is pressed via the confirmation screen shown in FIG. 4 and displayed on the display panel 113, the image forming apparatus 1 reboots without reprocessing the interrupted stapling job.

By contrast, if the OK button is pressed after moving the printed sheets ejected on the paper output tray 116 to the inserter 118 in accordance with the instruction displayed on the confirmation screen shown in FIG. 4 and displayed on the display panel 113, the sheet detector 134 detects that the printed sheets are set on the inserter 118. After detecting that the printer paper is set on the inserter 118, the sheet detector 134 tells the print job processor 135 that it is possible to perform reprocessing.

In this case, the sheet detector 134 detects that the printed sheets are set on the inserter 118 by pressing the OK button displayed on the confirmation screen shown in FIG. 4. However, this is just an example, and the sheet detector 134 can detect that the printed sheets are set on the inserter 118 by receiving a detecting signal from a sensor etc. that detects paper set on the inserter 118.

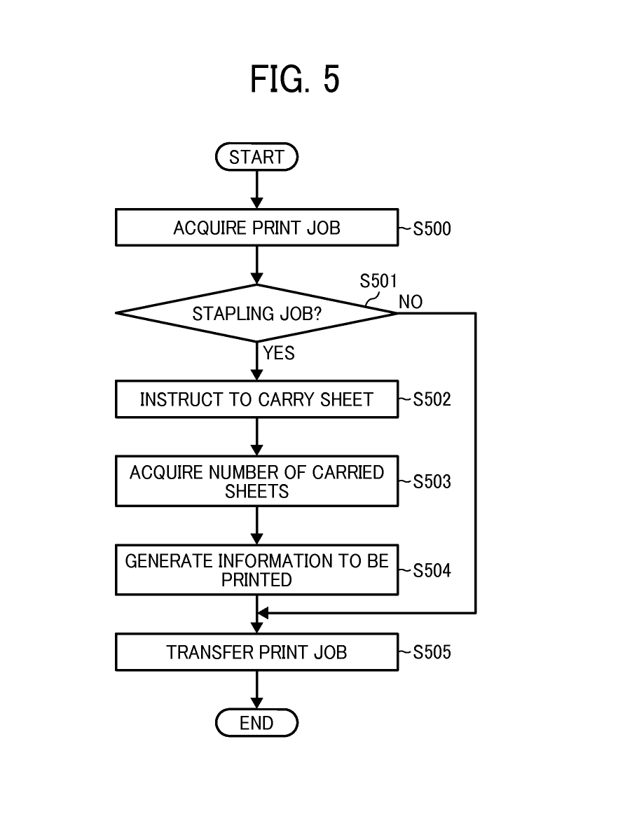

After receiving the processable notification from the sheet detector 134, if the print job processor 135 receives the print job input from the input/output controller 102, the print job processor 135 performs processing in accordance with the received print job. (That will be described in detail later with reference to FIG. 5.) After receiving an instruction to carry the sheet from the print job processor 135 (described later), the sheet carriage controller 136 controls the engine controller 101 and carries the printed sheets set on the inserter 118 to the stapling tray 117. After the sheet carriage controller 136 starts carrying the printer paper, the counter 137 counts the number of printed sheets carried to the stapling tray 117 from the inserter 118.

Next, a specific process performed by the print job processor 135 is described below with reference to FIG. 5. FIG. 5 is a flowchart illustrating a process performed by the print job processor 135. As shown in FIG. 5, the print job processor 135 acquires the print job input from the input/output controller 102 in S500. After acquiring the print job, if the acquired print job is not the stapling job (NO in S501), the print job processor 135 transfers the acquired print job to the image processor 103 in S505.

By contrast, if the acquired print job is the stapling job (YES in S501), the print job processor 135 instructs the sheet carriage controller 136 to carry the printed sheets set on the inserter 118 in S502. Subsequently, the print job processor 135 acquires the number of printed sheets carried from the inserter 118 to the stapling tray 117 input from the counter 137 in S503.

After acquiring the number of carried printed sheets, the print job processor 135 generates print target information as document information to be printed or image information to be printed in S504. More specifically, for example, the print job processor 135 deletes page information to be printed from the first page for the acquired number of carried sheets and generates new print target information deleting information on those pages.

For example, if the number of carried printed sheets is six, the print job processor 135 generates new print target information after deleting page information to be printed from one to six. This is because the pages for the number of carried printed sheets has already been printed before interrupting the printing process, and in reprocessing, it is necessary to print pages except those pages only without reprinting those pages included in the print job.

After generating the new print target information, the print job processor 135 changes the print target information included in the print job acquired in S500 into the generated new print target information and transfers the print job to the image processor 103 in S505. That is, the image processor 103 generates drawing information for unprinted pages due to the interruption of the printing process only based on the transferred print job.

As described above, the drawing information is generated by transferring the print job to the image processor 103 by the print job processor 135, and the printing process is performed based on the generated drawing information and the printed sheets are carried to the stapling tray 117. That is, the print job processor 135 functions as an image forming and outputting controller that instructs the print engine 115 to form and output images other than specified images based on the number of sheets carried from the inserter 118 to the stapling tray 117 among images to be printed and to carry the printed sheets to the stapling tray 117.

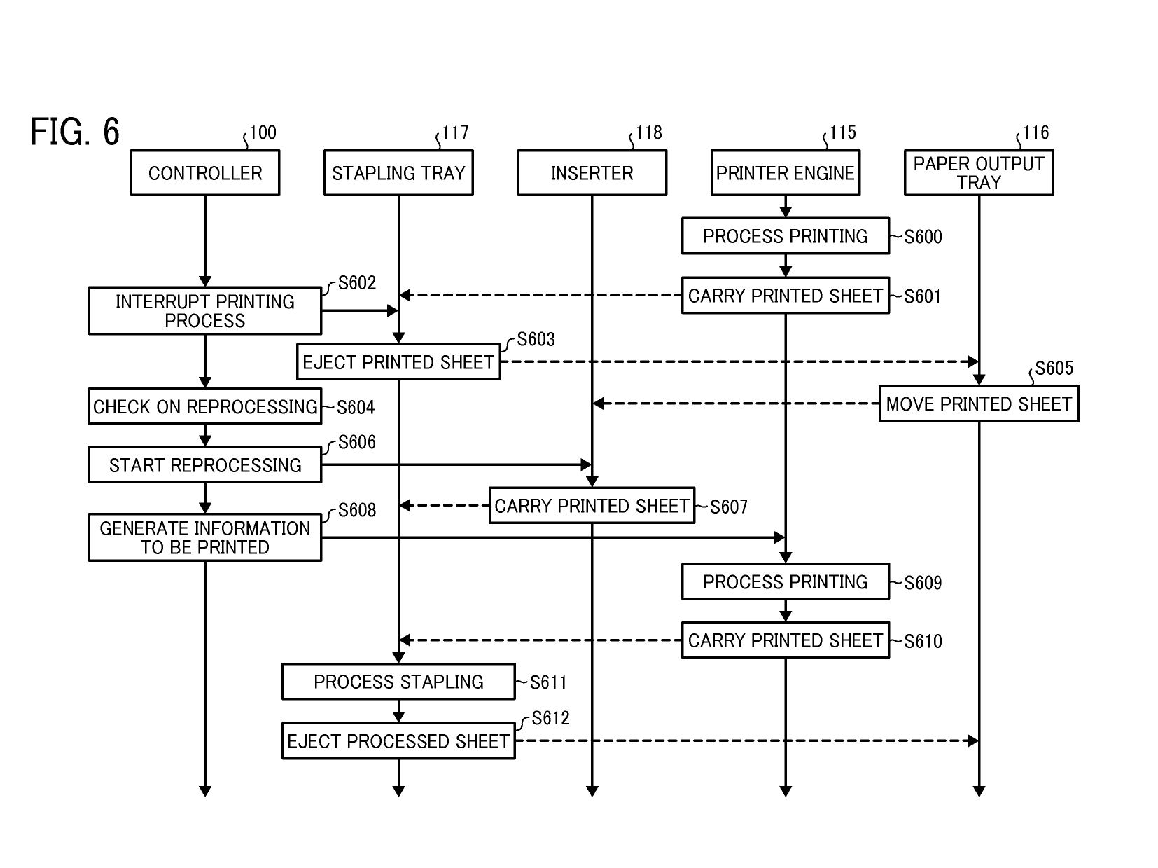

An operation of the image forming apparatus 1 in this embodiment is described below with reference to a sequence diagram shown in FIG. 6. Here, an operation that the process is interrupted due to unexpected shutdown of the image forming apparatus 1 in process of performing the printing process based on the stapling job and the interrupted process is reprocessed is taken as an example. In FIG. 6, solid arrows indicate flow of data such as control signals and notifications, and dashed arrows indicate flow of paper.

As shown in FIG. 6, the print engine 115 executes the printing process based on the stapling job in S600. The print engine 115 that executes the printing process carries the output printed sheets to the stapling tray 117 in S601. If the image forming apparatus 1 is shut down and rebooted during the printing process by the print engine 115, the controller 100 tells the stapling tray 117 that the printing process is interrupted in S602.

After receiving the notification, the stapling tray 117 ejects the stored printed sheets carried from the print engine 115 to the paper output tray 116 in S603. After detecting the improper shutdown of the image forming apparatus 1, the controller 100 displays the reprocessing confirmation screen shown in FIG. 4 on the display panel 113 in S604.

After checking the reprocessing confirmation screen that the controller 100 displays, the printed sheets ejected on the paper output tray 116 are moved to the inserter 118 by a user operation in S605. After detecting that the printed sheets are set on the inserter 118, if the controller 100 receives the stapling job, the controller 100 starts reprocessing the stapling job in S606.

After starting reprocessing the stapling job, the inserter 118 carries the set printed sheets to the stapling tray 117 in S607. The controller 100 that starts reprocessing the stapling job generates the print target information based on the number of printed sheets carried from the inserter 118 to the stapling tray 117 in S608.

The print engine 115 performs the printing process based on the drawing information generated based on the print job including the print target information generated by the controller 100 in S609. That is, the print engine 115 prints pages other than pages already printed before interrupting the printing process. The print engine 115 performing the printing process carries the output printed sheets to the stapling tray 117 in S610.

As a result, after carrying the printed sheets output before interrupting the printing process from the inserter 118 into the stapling tray 117, the printed sheets of the remaining pages not printed due to the interruption of the printing process are carried into the stapling tray 117. The stapling tray 117 performs the stapling process on the printed sheets carried from the inserter 118 and the printed sheets carried from the print engine 115 in S611. After performing the stapling process, the stapling tray 117 ejects the stapled printed sheets onto the paper output tray 116 as the processed sheets in S612.

As described above, in this embodiment, if image formation and output are interrupted due to an improper shutdown of the image forming apparatus 1, after restarting the image forming apparatus the printed sheets set on the inserter 118 are carried to the post-processing tray 117, images are formed on the remaining pages were not imaged and output due to the interruption of the image forming and outputting process and those pages are carried to the post-processing tray 117, the post-processing is performed on the printed sheets carried to the post-processing tray 117 and stored in the post-processing tray 117, and the post-processed printed sheets are ejected onto the paper output tray 116. Consequently, since the printed sheets output before interrupting the image forming and outputting process are carried to the post-processing tray 117 again and reused without being considered as invalid sheets that cannot be reused and the image forming and outputting process is performed on the remaining pages not output yet only, it is possible to reduce the consumed paper and toner.

In the case described above, the information on the number of printed sheets used for generating the print target information in reprocessing is acquired by counting the number of printed sheets carried from the inserter 118 to the stapling tray 117. Alternatively, the information on the number of the printed sheets can be input via the display panel 113, etc., or the information on the number of the printed sheets can be ascertained by the print manager 132 that manages the status of the printing process based on the print job based on the processing status at the time of interrupting the printing process.

In the embodiment described above, the number of printed sheets carried from the inserter 118 to the stapling tray 117 is considered the number of pages that are deleted from the print target information, that is, the single-sided printing process is performed on the printed sheets. However, it is possible to apply the present invention to duplex printing. In that case, after acquiring the setting value for printed side (either single-sided printing or duplex printing) included in the setting information of the print job, the print job processor 135 generates the print target information deleting page information for the number of carried sheets starting from page 1 in case of the single-sided printing. By contrast, if the setting value for printed side is duplex printing, the print job processor 135 generates the print target information deleting twice the number of carried sheets from page 1.

In the embodiment described above, the screen generator 133 generates the confirmation screen shown in FIG. 4 that displays the instruction to move the printed sheets to the inserter in case of reprocessing. Other than that, the screen generator 133 can generate the reprocessing confirmation screen separately from the screen that displays the message to instruct to move the printed sheets to the inserter. In that case, by inputting to perform reprocessing on the reprocessing confirmation screen by a user operation, the screen that displays the instruction to move the printed sheets is displayed.

In the embodiment described above, after the sheet detector 134 reports the reprocessable status, if the print job processor 135 receives the stapling job it starts to reprocess. Alternatively, the print job processor 135 can start reprocessing if the sheet detector 134 detects that the printed sheets are set on the inserter 118 as a trigger. In that case, the print job processor 135 receives the interrupted stapling job from the printing manager 132.

The embodiment described above can be applied to the case in which the number of output copies is set as multiple in the printing job that includes post-processing. In that case, if the image forming and outputting process based on that kind of print job is interrupted, the printing manager 132 memorizes the number of copies already finished at the time of the interruption. After starting reprocessing the interrupted process, the print job processor 135 calculates the number of copies necessary to perform image forming process from the number of finished copies memorized by the printing manager 132 and performs image forming and outputting process only for the remaining number of copies.

As a result, by adopting the configuration described above, even if the image forming and outputting process is interrupted based on the print job including post-processing whose number of output copies is set as multiple, since the copies already finished before the interruption can be reused and it is necessary to perform the image forming and outputting process for only the remaining number of copies, it is possible to reduce the consumed paper and toner than forming and outputting images on all pages in reprocessing, and that results in reducing the printing cost in reprocessing. In addition, in the combination of the embodiment that processes the remaining number of copies and the embodiment that processes the remaining number of pages, in forming and outputting images based on the print job that includes post-processing whose number of output copies is set as multiple, even if the image forming and outputting process is interrupted halfway through the image forming and outputting process for one copy among multiple copies, it is possible to reuse the finished copies and the printed sheets.

Numerous additional modifications and variations are possible in light of the above teachings. It is therefore to be understood that, within the scope of the appended claims, the disclosure of this patent specification may be practiced otherwise than as specifically described herein.

As can be appreciated by those skilled in the computer arts, this invention may be implemented as convenient using a conventional general-purpose digital computer programmed according to the teachings of the present specification. Appropriate software coding can readily be prepared by skilled programmers based on the teachings of the present disclosure, as will be apparent to those skilled in the software arts. The present invention may also be implemented by the preparation of application-specific integrated circuits or by interconnecting an appropriate network of conventional component circuits, as will be readily apparent to those skilled in the relevant art.

Each of the functions of the described embodiments may be implemented by one or more processing circuits. A processing circuit includes a programmed processor, as a processor includes circuitry. A processing circuit also includes devices such as an application specific integrated circuit (ASIC) and conventional circuit components arranged to perform the recited functions.

1. An image forming apparatus, comprising:
an image forming unit to form an image on a sheet;
a post-processing unit to mount printed sheets each of which having the image formed thereon, and perform post-processing on the printed sheets;
a carrier unit to mount sheets to be carried to the post-processing unit;
a sheet carriage controller to carry the sheets held on the carrier unit to the post-processing unit if the post-processing is interrupted and then resumed;
a counter to count the number of sheets carried from the carrier unit to the post-processing unit; and
an image forming controller to instruct the image forming unit to form an image other than images specified based on the counted number of sheets among images to be output for the post processing and carry the printed sheets on which the image is formed to the post-processing unit.

2. The image forming apparatus according to claim 1, wherein the image forming controller acquires a number of copies for which post-processing is finished at interruption and instructs the image forming unit to perform the image forming process and the post-processing for remaining copies excluding the number of copies for which the post processing is finished.

3. The image forming apparatus according to claim 1, further comprising a sheet detector to detect that the sheets are held on the carrier unit, wherein the sheet carriage controller carries the sheets detected being held on the carrier unit to the post-processing unit.

4. The image forming apparatus according to claim 3, further comprising:
a display; and
a screen generator to generate on the display a screen that displays information that instructs to hold the printed sheets ejected from the post-processing unit due to the interruption of the image forming process on the carrier unit,
wherein the sheet detector detects that the sheets are held on the carrier unit by detecting an operation indicating that the printed sheets are held on the carrier unit via the generated screen.

5. The image forming apparatus according to claim 3, wherein the carrier unit further comprises a sensor to detect that a sheet is held, and the sheet detector detects that the sheet is held on the carrier unit by receiving a detection signal from the sensor.

6. An image forming apparatus control method, comprising the steps of:
forming an image on a sheet;
holding printed sheets each of which having the image formed thereon for post-processing after forming the image;
holding sheets to be carried to the holding for post-processing;
carrying the sheets held to the holding for post-processing step if the image forming process that includes the post-processing is interrupted and then resumed;
counting the number of sheets carried from the holding to be carried to the holding for post-processing; and
instructing to form an image other than images specified based on the counted number of sheets among images to be output for the post processing and carrying the printed sheets on which the image is formed and held for post-processing.

7. A non-transitory, computer-readable recording medium storing a program that, when executed by a computer, causes a processor to implement a method of controlling an image forming apparatus, the method comprising the steps of:
forming an image on a sheet;
holding printed sheets each of which having the image formed thereon for post-processing after forming the image;
holding sheets to be carried to the holding for post-processing;
carrying the sheets held to the holding for post-processing step if the image forming process that includes the post-processing is interrupted and then resumed;
counting the number of sheets carried from the holding to be carried to the holding for post-processing; and
instructing to form an image other than images specified based on the counted number of sheets among images to be output for the post processing and carrying the printed sheets on which the image is formed and held for post-processing.
